(19) United States
(12) Patent Application Publication
(10) Pub. No.: US 2008/0060558 A1
(43) Pub. Date: Mar. 13, 2008

(54) Attached foldup camper stand

(76) Inventor: John R. Blood, Qualicum Beach (CA)

Correspondence Address: John Blood, 1249 Winchester Rd., Qualicum Beach, BC, V9K1W9, US

(21) Appl. No.: 11/899,158

(22) Filed: Sep. 5, 2007

(30) Foreign Application Priority Data
Sep. 12, 2006 (CA) 2559505

(51) Int. Cl. B60S 9/02

(52) U.S. Cl. 108/18; 108/132; 108/147.2; 296/172

(57) ABSTRACT

This invention provides a stand for a camper that will allow the camper to be used in an elevated position when it is removed from the truck. The stand is to be attached to the bottom of camper. The legs easily fold up to put the camper back on the truck, and fold down when it is off the truck. The legs are designed with axle and angle braces for side-to-side stability, and fold down past the 90-degree angle so the legs will tension the folding braces for front to rear stability. The main frame, which attaches to the camper, is the size of the camper structure that is within the truck box, therefore the stand supports the camper as it would be supported when in the truck box. This stand can be attached as an after market product or could be used as the base for construction of a camper.

### BACKGROUND OF THE INVENTION

Campers are great RV's as you have the use of the vehicle without camper for all the non-camping time. The disadvantage of the camper as used today is the necessity of keeping the camper mounted on the truck at all times if you want to use it as a camper.

It is the purpose of this invention to allow a camper to be removed from the truck with the normal jacks, then simply fold down legs, which, along with the frame they are attached to, allow the camper to be supported for use off the truck. The legs have adjustable feet to allow for some unevenness of the surface the camper is placed on. There are no pins braces bolts etc., to be removed or installed for setup or takedown, which makes for simplicity of use.

The closest relevant patents I found are.

| | |
|---|---|
| U.S. Pat. No. 6168227 | Lofting |
| U.S. Pat. No. 4723744 | Baker |
| U.S. Pat. No. 5141197 | Mckaay |
| CAN 2309864 | Brown |

There are several problems with these various solutions to using a truck camper when it is off the truck. One of the major issues is stability. The telescoping legs, which are fixed with pins, allow only finite variations in length of leg. This would allow movement of camper and stand and thus an unstable situation. By using threaded legs with feet and a surface on the foot which facilitates adjusting, the adjustment is infinite within the range of the thread. Adjustments to each leg can be made while weight is on stand thus making adjustments for settling possible.

Another problem is removing and or adding pins, braces, bolts, etc. These could easily be misplaced and are a nuisance to carry along. The design of my stand allows one person to easily and safely raise and lower the legs. Having the legs fold down past 90 deg. gives front to rear stability. The threaded foot arrangement allows easy adjustment for maximum stability.

The variety of construction of camper bases can create a problem getting a secure attachment of legs. Having a frame with center longitudinal support allows any camper design to be attached, as the attachment can take place with screws at any location on the frame assembly.

### FIGURES INCLUDED

FIG. 1 Bottom view of stand with legs in lowered position

FIG. 2 Side view of stand with legs in lowered position

FIG. 3 Folding brace (mirror image of FIG. 4)

FIG. 4 Folding brace (mirror image of FIG. 3)

FIG. 5 Leg and foot assembly

FIG. 6 View of attachment method

### SUMMARY OF THE INVENTION

The invention is a stand with fold up legs that allows a camper to be lived in, in an elevated position when off the truck. The legs fold up to allow mounting on a truck easily When removed from truck the stand will support the camper basically the same as a when the camper is on the truck. The frame if added as an aftermarket device only adds a couple of inches to height. If the camper were built on the frame it would not add any additional height.

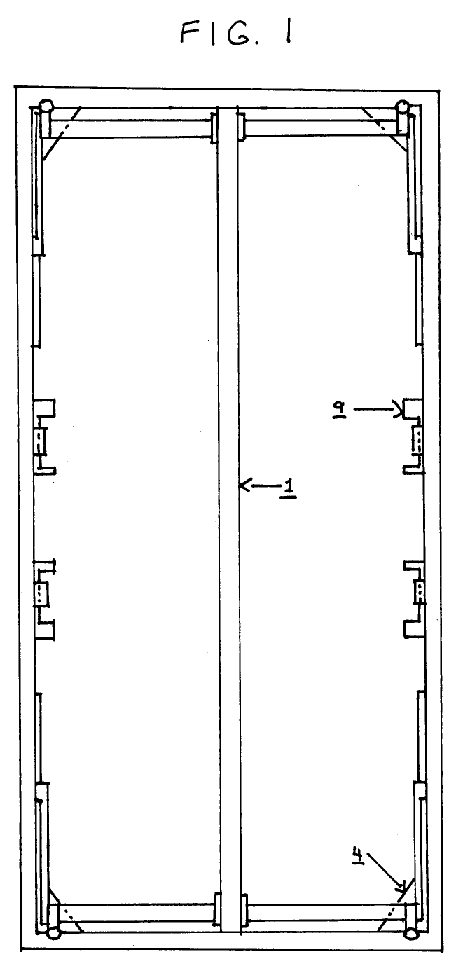

The frame as shown in FIG. 1, is a rectangular frame, which is the size of the portion of the camper base, which is located within the truck box. There is a center part to the frame (1), which runs longitudinally, centered between the longest sides of the frame. This center support along with the outside parallel member provides the attachment and support for the four legs.

Each leg comprises a horizontal upper piece (2) with an axle (3) through it, which allows each leg to pivot. The axle is of a length to fit between the aforementioned supporting members. There are axle support blocks on each end of the axle. The axle blocks consist of a rectangular block with a round hole to fit the axle. The blocks allow the assembled leg and axle to be positioned between supporting members adjusted for position and secured in place. (The axle could be fitted directly to frame once exact positioning is set.) The frame has a gusset (4) in each corner placed to support the leg firmly when in a lowered position. The leg has the vertical member (5) attached to the upper member at the outer end, at a right angle to the horizontal portion of the leg. The end of this leg has a radius (7) at the top to match the gusset when the leg is pivoted on the axle. This portion of the leg (5) has a brace (6) at an angle (approx 45 degree) attached to upper brace (2) to give sideways stability.

The bottom portion of the leg is threaded to accommodate a threaded foot (8). This foot allows for the adjustment of each leg for height. The foot has a bottom of smaller diameter than the frame plus a surface to allow turning by a wrench. This arrangement of the foot allows it to be adjusted to shortest position, then the leg is raised with the foot above sliding support plate (9), the sliding plate (9) is then moved to support the foot and leg in a raised position for mounting the camper on truck.

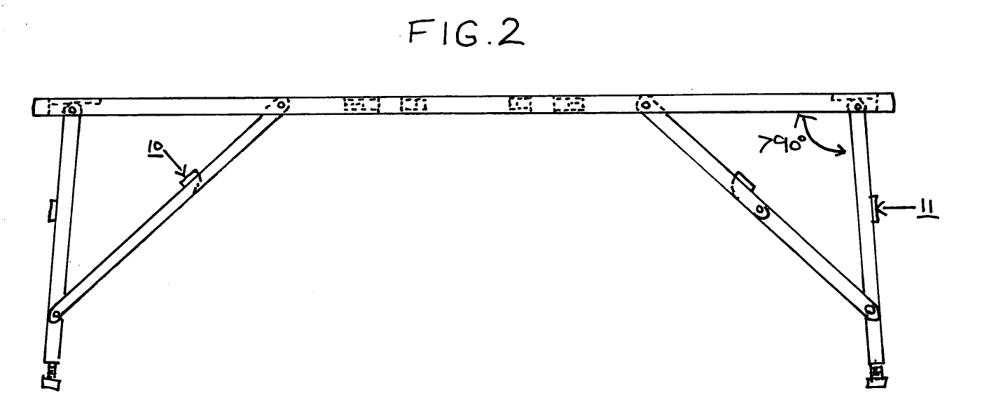

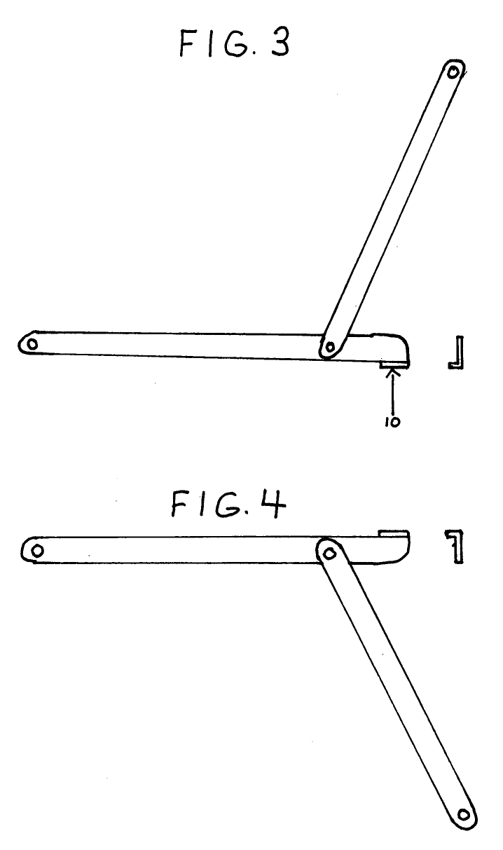

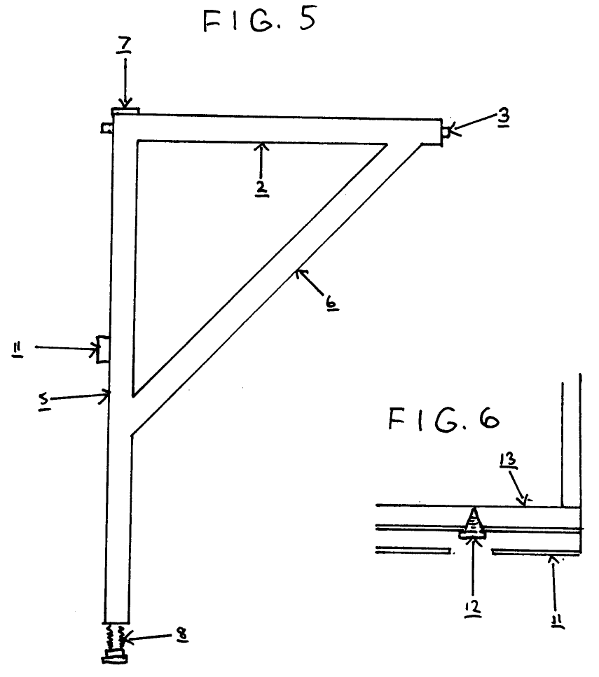

There is a folding brace (FIG. 3 and FIG. 4) attached to each leg as shown in FIG. 2. The other end of each brace attaches to the frame. Each end of the brace attaches via a pivot rod. Two of each type of brace is required (Two of type in FIG. 3 and two of type in FIG. 4). One end of folding brace is attached to lower portion of the leg and other end at a corresponding location on the frame when the leg is in a raised position. One portion of brace is longer and protrudes past center pivot position (FIG. 3 and FIG. 4). This portion of brace has a tab (10), which stops brace from passing a straight alignment when lowered. The aforementioned braces are of a length to allow leg to pass 90-degree angle (FIG. 2) when lowered thus creating an outward tension on leg, and on braces to give front to back stability to camper. Each leg has attached a small plate (11), which causes the folding brace to be held above the bottom edge of the frame when the leg is raised to keep said folding brace out of way for loading camper on truck.

The camper frame is made of rectangular tube metal. The stand is attached to camper via screws. Larger holes are made in bottom of frame wall (see 11 in FIG. 6) and holes to fit screws are drilled in upper frame wall to suit the screw being used (see 12 in FIG. 6). These holes and corresponding screws are positioned to allow screws to be attached at suitable positions on camper structure.

The embodiments of the invention in which an exclusive property or privilege is claimed are defined as follows:

1. A stand to be fixed to the bottom of a camper allowing camper to be used when not mounted on truck comprising
(a.) A frame corresponding to support structure of camper within truck box having in addition a center support,
(b.) Pivoting legs providing side to side stability, and folding braces which allow legs to descend past 90 degree angle creating tension on folding braces and therefore front to back stability.
(c.) Threaded leg bottoms and foot attachment for adjusting leg length.

2. A stand as described in claim 1, on which each leg has a top portion which pivots on a axle, a piece adjoined at 90 degrees and having an angle brace adjoining the aforementioned parts together giving sideways stability.

3. The stand of claim 1 and legs of claim 2, having a folding brace with one section longer having a tab to limit unfolding to straight configuration.

4. The stand of claim 1 wherein the folding braces are of a length and are attached in position to allow legs to swing past 90 degree from horizontal raised position causing tension on said braces and thus causing front to back stability to camper stand.

5. The stand of claim 1, wherein the legs have a threaded bottom to accept threaded the foot, which comprises a shaft with an adjustment surface and a circular pad on the bottom. This adjustment method allows leg length adjustment without raising stand and allows infinite adjustment of each leg within thread range.

6. The stand of claim 1, wherein the threaded foot arrangement allows adjusting foot when leg is raised to sit on a sliding plate and hold leg in a retracted position.

7. The stand of claim 1, wherein the leg of claim 2 has a tab attached to support the folding brace when in a retracted position.
